(19) United States
(12) Patent Application Publication
(10) Pub. No.: US 2006/0040776 A1
(43) Pub. Date: Feb. 23, 2006

(54) Fixed gear bicycle hub

(76) Inventor: Scott Hansen, Mashpee, MA (US)

Correspondence Address: Thomas Kahrl, Box 1177, West Falmouth, MA, 02574, US

(21) Appl. No.: 10/818,309

(22) Filed: Aug. 23, 2004

(51) Int. Cl. F16H 55/12; F16H 55/30

(52) U.S. Cl. 474/160; 474/152

(57) ABSTRACT

A fixed bicycle hub assembly for changing (removing and replacing) the hub (rear) gear on a fixed gear bicycle hub so that another gear can be used; comprising a chain, a molded unitary hub having molded keys protruding from the hubs faces and threaded bolt holes on both faces, a single speed chain disc received by the molded unitary hub having a cog ring comprising integral keyways and bolt holes, a plurality of locking keys and arcuate keyways and fastening bolts for changing (removing and replacing) the hub (rear) gear on a fixed gear bicycle hub so that another gear can be used.

### BACKGROUND OF INVENTION

1. Field of the Invention

The present invention is directed toward arrangements for changing the cog set on a rear wheel bicycle hub so that another cog set can be used. In particular this invention incorporates an arrangement using a molded unitary hub having two faces with arcuate molded keys protruding from the hub's faces and threaded bolt holes on both the faces. This unitary hub receives a cog set having consisting of a single speed chain disc having integral arcuate keyways, bolt holes and a cog ring. The present invention is directed for use on a fixed gear bicycle.

2. Background Information

The oldest and simplest type of bicycle was a fixed-gear bicycle wherein the rear chain cog was securely affixed to the rear wheel. More recently cycling with fixed-gear Road Bikes is becoming an increasingly more popular form of recreation as well as a means of transportation. Another form of fixed-gear bicycles in addition to Road Bikes is Track Bicycles which are directed to a very popular competitive sport for both amateurs and professionals.

A fixed-gear Road Bikes is a single-speed bike without a freewheel; that is, whenever the bike is in motion, the pedals will go around. You cannot coast on a fixed-gear machine. When you ride a fixed gear, you feel a closer communion with your bike and with the road. When you ride a fixed gear, the need to push hard to get up the hills forces you to ride at a higher intensity than you otherwise might. Really steep hills may make you get off and walk, but the hills you are able to climb, you will climb substantially faster than you would on a geared bicycle. When you descend, you can't coast, but the gear is too low. This forces you to pedal at a faster cadence than you would choose on a multi-speed bicycle. High-cadence pedaling improves the suppleness of you legs. High rpm's force you to learn to pedal in a smooth manner because if you don't, you will bounce up and down in the saddle. Most cyclists coast too much. Riding a fixed-gear bike will break this pernicious habit. Coasting breaks up your rhythm and allows your legs to stiffen up. Keeping your legs in motion keeps the muscles supple, and promotes good circulation.

With fixed gear gives you a very direct feel for traction conditions on slippery surfaces. This makes them particularly suitable for riding in rainy or icy conditions. This same feel for traction will help you learn exactly how hard you can apply your front brake without quite lifting the rear off the ground. Most fixed-gear riders only use a front brake; a rear brake is quite unnecessary on a fixed-gear machine. Inasmuch as you are more solidly connected to the bike, you have better control of it in bumpy conditions or in difficult corners.

A fixed-gear bike also has a substantially shorter chain. A properly set-up fixed gear has a perfectly straight chain line. This, plus the absence of derailers pulleys, makes a real improvement in the drive-train efficiency, an improvement you can feel.

Many people think of fixed-gear bikes and track bikes as synonymous, but they aren't. Track bicycles are designed for use on velodromes (bicycle tracks). Some riders do ride them on the road, but they are less than ideal for road use. Track bicycles are set apart from road bicycles by more than the fact that they have a fixed gear. Track bicycles do not have brakes. Brakes are unnecessary on tracks, since everybody is moving in the same direction, and none of the other bikes you are riding with can stop any faster than you can. (Most tracks forbid the use of bikes that have brakes, as a safety measure!) Whether the bicycle is used for recreation, transportation or competition, there is a need for the bicycle industry to improve the means of attaching the cog set to the rear wheel hub.

This particular component of the bicycle, i.e., the rear bicycle hub, has been redesigned over the years to have more sprockets or gears. In particular, most of today's bicycles have at least seven sprockets. Moreover, some bicycles even have nine sprockets. However all current bicycle hubs require special tools to be changed. which is not conducive to quick gear change on the side of the road for a fixed gear bicycle. Hence there clearly are demands for a simplified mounting structure and easy mounting method.

### PROBLEMS WITH PRIOR ART

Current Hub Design:

The way a cog set (also referred to as sprockets) is mounted on a bicycle hub currently is via a set of right-handed threads to which the cog is screwed onto. A second set of threads, which are left-handed, accepts a left-hand threaded lock ring to keep the cog from spinning off when back pressure, also called braking force is applied to the cog. This method of mounting means the cog set must be tightened to its full depth of thread using a special tool (chain whip), and then the lock ring must be tightened to the cog with another special tool (lock ring pliers). This interference between the two is essential for keeping the cog mated to the hub and the lock ring mated to the cog. Almost invariably, however, the torque provided using the chain whip is insufficient to tighten the cog to its full depth. Consequently, the cog tightens a little more onto the right handed threads under pedaling forces leaving a small gap between the cog and the lock ring. This allows the cog and lock ring to slip back and forth wearing out the threads prematurely causing the lockring to either have fewer threads to grab hold of or fall off completely. In either case an unsafe situation arises because this style of racing bike is operated without the use of a hand brake. Braking force is applied via the pedals to the rear wheel through the cog. If the lockring is compromised in any way then so is the braking ability.

In view of the above, there exists a need for an improved rear hub assembly for a bicycle wheel which overcomes the above mentioned problems in the prior art, as well as other needs, which will become apparent to those skilled in the art from the disclosure. With the INI and the eye2knuckle interface there is no lockring. Therefore, no special tools and no need to worry about torque loads initially applied to the cog when mounting. The shear stress and torque loads are taken by the three arcuate keyway or “Knuckles” as I am calling it. The three bolts do nothing but hold the cog flush to the hub face, which is the “Eye”. With this design there is also an added benefit of being able to do emergency trail side repairs. It uses a torx wrench, size 25, for the mounting bolts. This size currently used in the industry for disc brake rotors and is now available on most bike specific multi-tools.

Advantages of INI Hubs: One hub shell. Different size spacers for different spaced frames. Comes with a 15 tooth cog. Easy trail side maintenance. No special tools required. Throw your lock-ring pliers away or sell them to anyone who hasn't seen the INI light yet. Symmetrical zero dish lacing—One size spoke needed. Flip-flop style. Carry your spare on the non-drive side. Transfer of torque to non-drive side spokes is via gradual transition from one flange to the other. Need I say anymore.

The invention will be described for the purposes of illustration only in connection with certain embodiments; however, it is recognized that those persons skilled in the art may make various changes, modifications, improvements and additions on the illustrated embodiments all without departing from the spirit and scope of the invention.

### SUMMARY OF THE INVENTION

The present invention is directed toward arrangements for changing (removing and replacing) the hub (rear) gear on a fixed gear bicycle hub for use on a fixed gear bicycle so that another gear can be used. Such a hub system includes a chain, a hub, a chain ring, locking keys and arcuate keyways, and fastening bolts. For references purposes a fixed gear bicycle according to the present invention incorporates a rear hub in which the sprocket is rigidly connected to the hub, without a freewheel. The pedals of a fixed-gear bicycle revolve whenever the rear wheel turns; coasting is impossible. This type of gearing has previously been associated with track bicycle racing.

In particular the present invention incorporates an arrangement using a molded unitary hub having molded keys protruding from the hub's faces and threaded bolt holes on both the faces. This unitary hub receives a single speed chain disc having a cog ring (having integral arcuate keyways, and bolt holes). For references purposes a fixed gear bicycle according to the present invention incorporates a rear hub in which the sprocket is rigidly connected to the hub, without a freewheel. as an “Eye”. The hub is identified as an “InI”hub referring to one “Eye” on each side of said hub.

The advantage of the present invention embodied in a InI hub is that it has but one hub shell with different sized spacers for different spaced bicycle frames. Furthermore the InI hub comes with a 15 tooth cog and accomodates easy trail side maintenance as no special tools are required. With this InI hub you can throw your lock-ring away, you have symmetrical zero dish lacing. One size spoke needed. Flip-flop style. Carry your spare on the non-drive side. Transfer of torque to non-drive side spokes is via gradual transition from one flange to the other.

Eye2knuckle Interface: This is the revolution in cog/freewheel mounting. One tool needed. A torx, size 25. Same as a disc rotor and is now on most multi tools. The bolts actually don't see any shear stresses. That's the job of the three arcuate keyways called Knuckles. But, still recommended torque specs are 50 in-lbs. You don't want one to vibrate off in the middle of your ride so we have also put a little loc-tite on the threads.

INI—pronounced Eye n'αEye.”

Current Hub Design Information:

The way cogs are mounted currently is via a set of right-handed threads to which the cog is screwed onto. A second set of threads, which are left-handed, accepts a left-hand threaded lockring to keep the cog from spinning off when back pressure, also called braking force is applied to the cog. This method of mounting means the cog must be tightened to its full depth of thread using a special tool (chain whip), and then the lockring must be tightened to the cog with another special tool (lockring pliers).

With the INI and the eye2 knuckle interface there is no lockring. Therefore, no special tools and no need to worry about torque loads initially applied to the cog when mounting. The shear stress and torque loads are taken by the three arcuate keyway or “Knuckle” as I am calling it. The three bolts do nothing but hold the cog flush to the hub face, the “Eye.”.

With this design there is also an added benefit of being able to do emergency trail side repairs. It uses a torx wrench, size 25, for the mounting bolts. This size is currently used in the industry for disc brake rotors and is now available on most bike specific multi-tools.

One object of the present invention is to provide a rear hub assembly for a bicycle wheel wherein the cog set is easily changed with standard tools.

Yet another object of the present invention is to provide a single speed chain disc that is securely fastened to the Hub Shell.

Yet another object of the present invention is to provide a molded unitary hub having two faces with molded keys called “knuckle” protruding from the hub's faces and threaded bolt holes on both the faces that associate with corresponding keyways and bolt holes of a cog set.

Another object of the present invention is to provide a rear hub assembly for a bicycle wheel that permits the cog set to be substituted with a second gear having a different number of teeth while the bicycle is in use to accommodate a change in terrain having a different of angle of incline

These and other objects, features, aspects and advantages of the present invention will become apparent to those skilled in the art from the following detailed description, which, taken in conjunction with the annexed drawings, discloses preferred embodiment of the present invention.

### BRIEF DESCRIPTION OF THE DRAWINGS

Referring now to the attached drawings which form a part this original disclosure:

FIG. 1 is a partial exploded perspective view of the hub shell assembly in accordance with the present invention;

FIG. 2 is a side view of the hub shell in accordance with the present invention;

FIG. 3 is a front end view of the hub shell of FIG. 2;

FIG. 4 is a side view of the hub shell of FIG. 2 cut away for purposes of illustration;

FIG. 5 is a side view enlarged elevational view of the bicycle shell assembly in accordance with the present invention, with a portion of the hub shell broken away for purposes of illustration;

FIG. 6 is a side view of the hub shell assembly in accordance with the present invention;

FIG. 7 is a front end view of the hub shell assembly of FIG. 6;

FIG. 8 is a side view of the hub shell assembly of FIG. 6; cut away for purposes of illustration;

FIG. 9 is a side view of the hub axle assembly in accordance with the present invention;

FIG. 10 is a front elevational view of a cog set comprising a single speed chain disc in accordance with the present invention;

FIG. 11 is a front elevational view of a hub shell assembly with cog set with outer sprocket teeth in combination with freewheel in accordance with an alternate embodiment of the invention of FIG. 1;

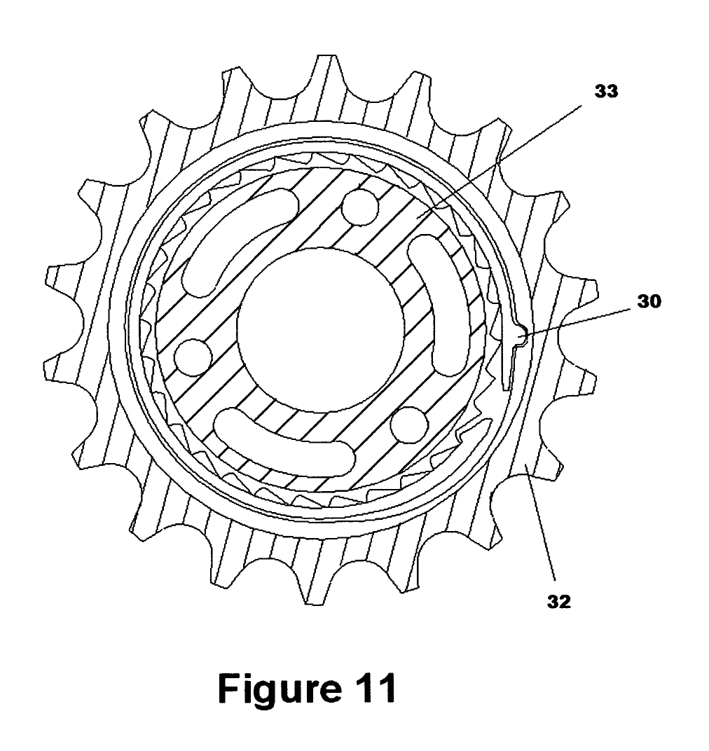

FIG. 12 is a detail enlargement of the interaction of the pawl and teeth of the cog set of FIG. 11;

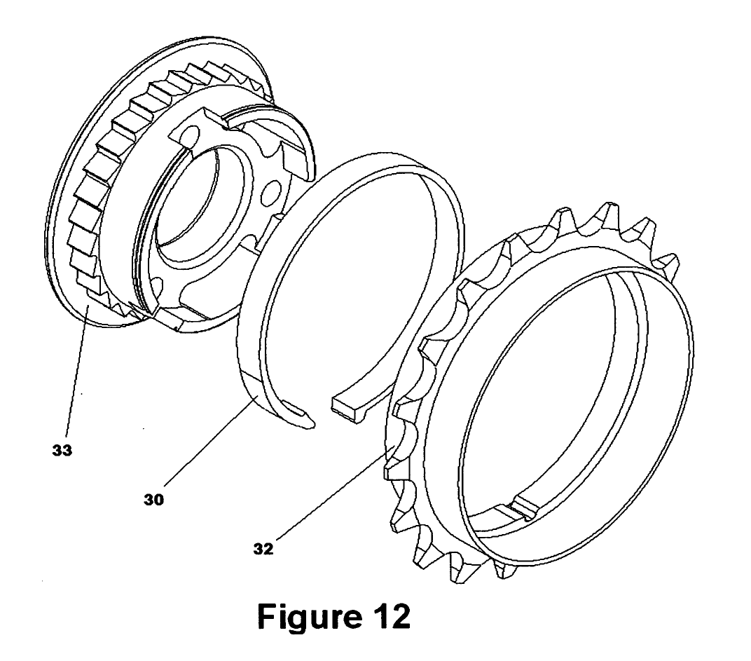

FIG. 13 is a front elevational view of the “knuckle” in combination with pawl of FIG. 1 1; and

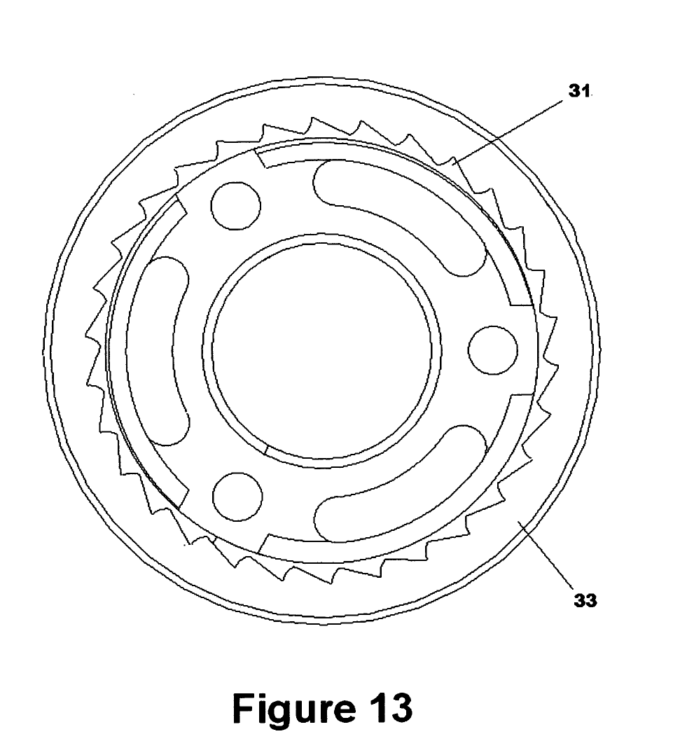

FIG. 14 is a front elevational view of the cog set disengaged from the knuckle of the hub shell of FIG. 11.

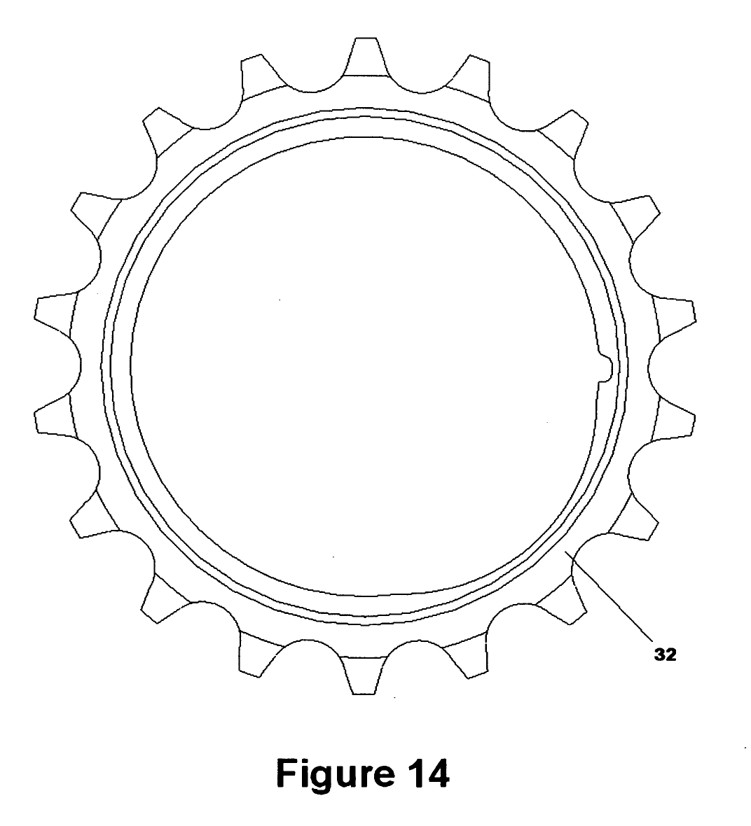

### DETAILED DESCRIPTION OF THE PREFERRED EMBODIMENTS

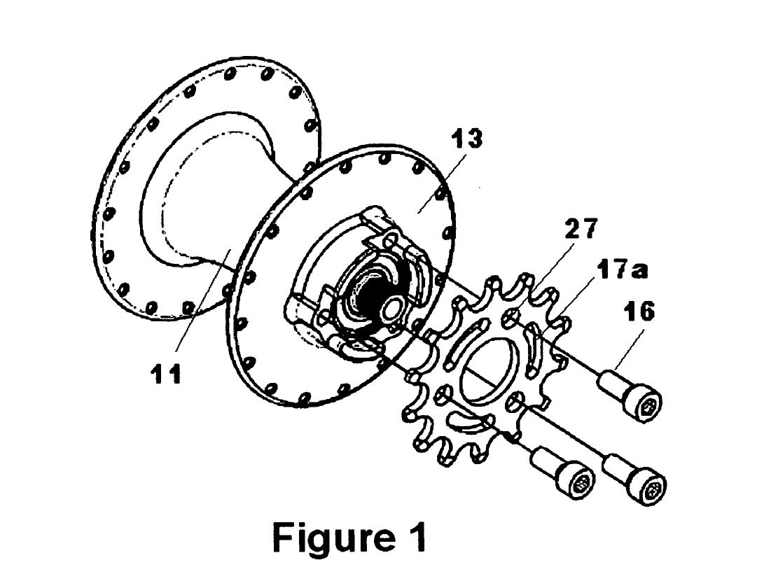

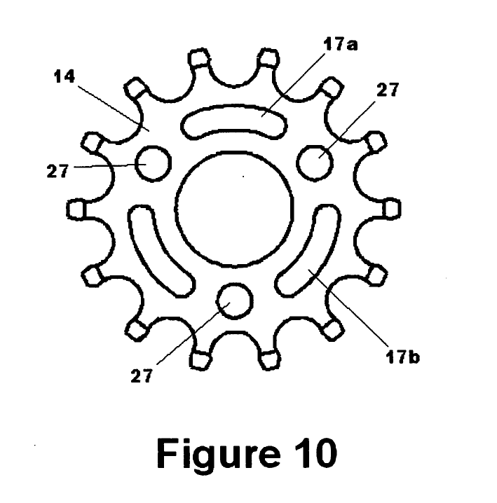

Referring initially to FIG. 1, a bicycle hub assembly 10 is illustrated comprising a molded unitary hub shell 12 having “Knuckles” 24 consisting of molded keys protruding from a first hub face 13a and a second hub face 13b and including a plurality of at least three threaded bolt holes 15 on both of said faces. The “Knuckles” associate with a cog set comprising a cog disc 14 having a single gear is shown in FIG. 10 and a bicycle chain 12 associates with said cog disc 14 for use on a bicycle (not shown) in accordance with the present invention. Since the parts of the bicycle are well known in the art, the parts of the bicycle will not be discussed or illustrated in detail herein, except as they are modified in accordance with the present invention. Moreover, various conventional bicycle parts such as brakes, drive sprockets, chain drives, derailers, additional sprockets, etc., which are not illustrated and/or discussed in detail herein, can be used in conjunction with the present invention.

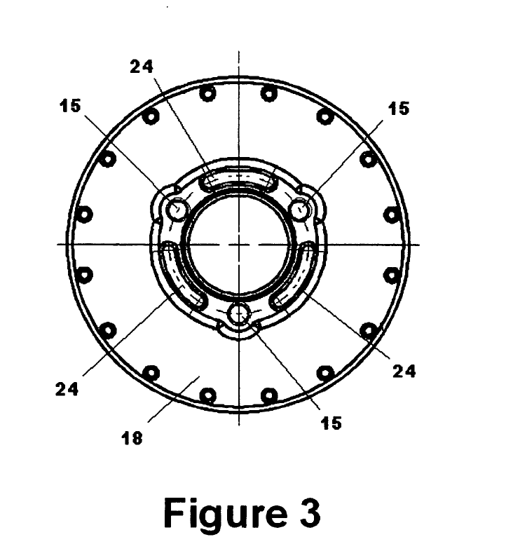

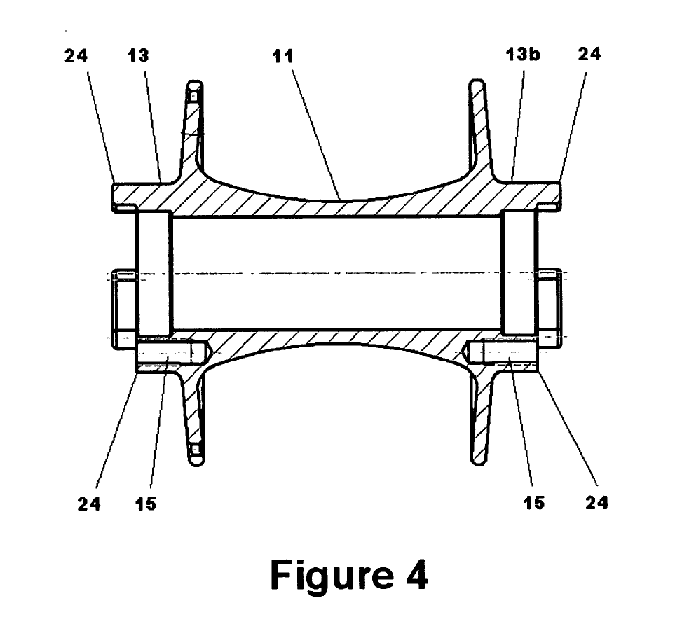

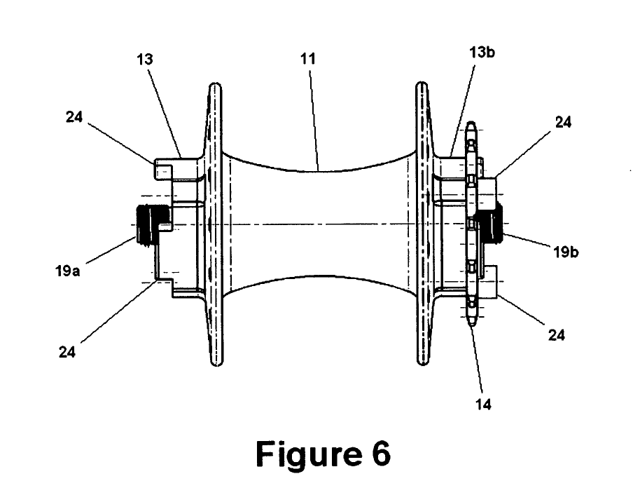

Turning now to FIGS. 1-10, the bicycle hub assembly 10 configured for use on a bicycle employing a fixed single gear so that said fixed gear can be substituted with a second gear having a different number of teeth while the bicycle is in use to accommodate a change in terrain having a different of angle of incline. Said bicycle hub assembly 10 comprises in combination a chain 12, a molded unitary hub 12 having molded keys or “Knuckles” 24 protruding from the hubs faces 13a and 13b configured to receive a single speed cog disc 14 in association with “Knuckles” 24 having outer cog ring 18. The cog disc 14 comprises three integral arcuate keyways 17 and three cog bolt holes 27 to receive three locking keys or “Knuckles” 24 and three cog fastening bolts 16 for fastening the cog disc 14 on a molded unitary hub rendering the bicycle a fixed gear bicycle.

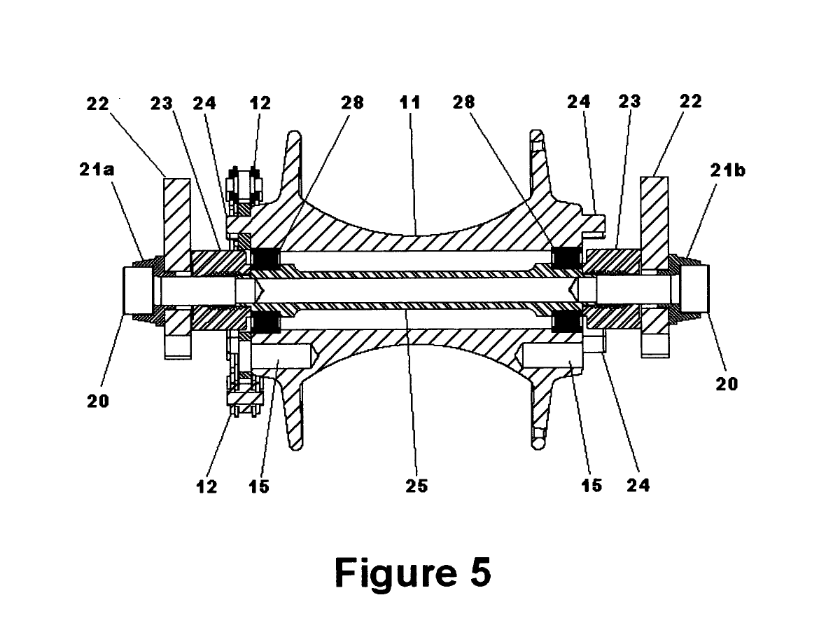

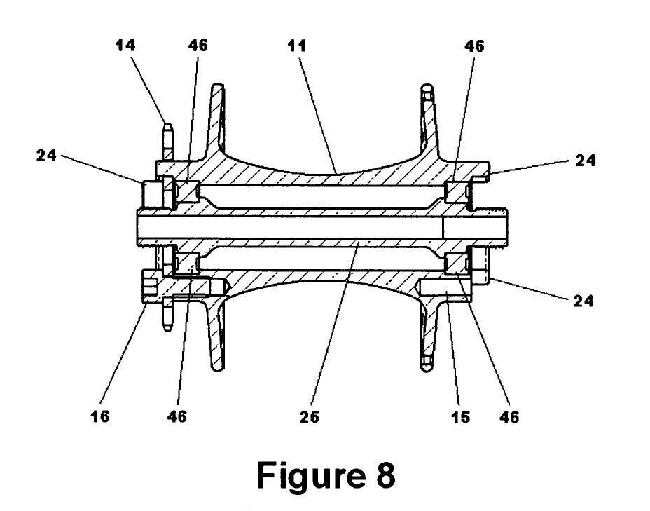

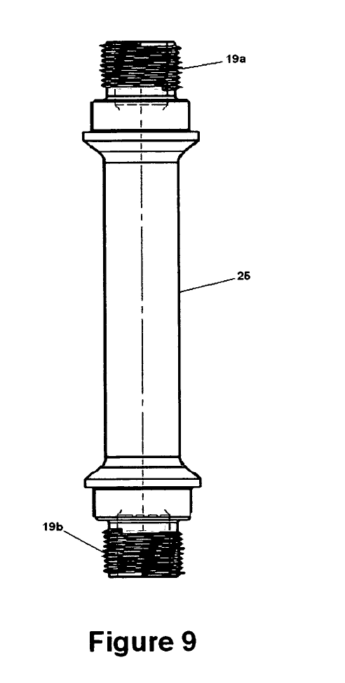

Referring to FIG. 5, there is shown a bicycle dropout 22 of a fixed gear bicycle supporting shown a hub axle 25 supporting a hub assembly 10 for use with conventional tools for installing and changing a rear cog disc 14 installed on said hub assembly. In FIG. 9 here is shown hub axle 25 having a center axis extending between a first frame mounting end 19a and a second frame mounting end 19b. FIG. 8 also discloses apportion of a chain 12 extending between a front chain drive sprocket not shown and a rear cog disc 14 for driving the fixed bicycle of the present invention.

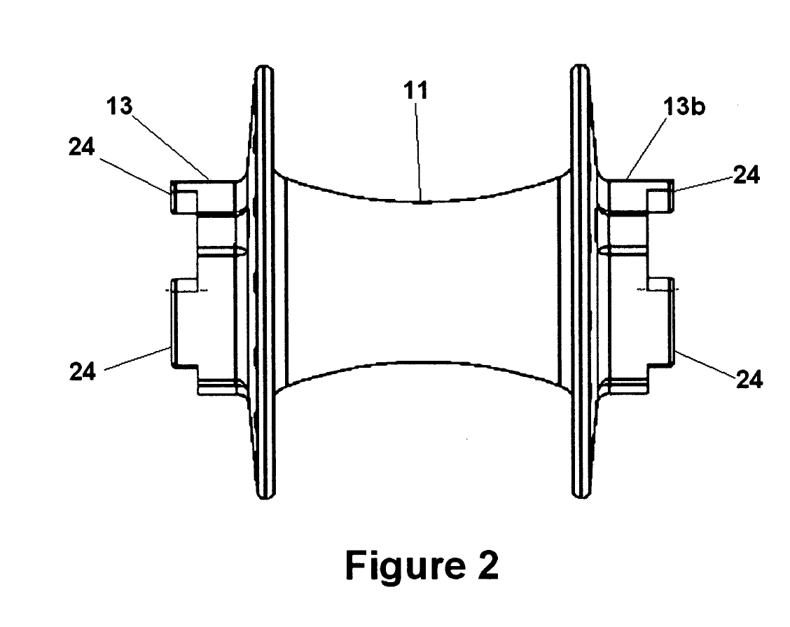

As is shown in FIG. 2 hub shell 26 is of unitary molded construction having a first hub face 13a and a second hub face 13b. Said hub faces each including three threaded bolt holes 27 as well as a plurality of three molded arcuate “Knuckles” 24 protruding from each of hub faces face 13a and a second hub face 13b configured to associate with locking keyways 17 of a cog disc 14.

Referring to FIGS. 1 & 2 a cog disc 14 may be selectively received by hub face 13a or 13b of the hub shell 26. Cog disc 14 includes three “Knuckles” 24 comprising coaxial locking keyways of arcuate shape, three non-threaded bolt holes 27 each arranged to receive respectively one cog bolt 16 having external threads associated with internal threads of 15 internally threaded bolt holes 15. The rear cog disc 14 also includes a peripheral cog ring 18 for receiving the drive chain 28. There is shown in FIG. 1 a plurality of cog bolts 16 in association with non-threaded cog bolt holes 27; wherein said cog bolts 16 can be employed for changing (removing and replacing) the rear cog disc 14 with standard tools so that another cog having different characteristics can be used.

As is shown in FIG. 5 the hub shell unit 26 comprises a molded unitary hub shell that includes a hub axle 25 that rotatably supports hub assembly 10 including rear cog disc 14 about a center axis of rotation by a pair of sealed bearings 44 mounted on bearing races 46 at each end of the hub axle 25. Hub assembly 10 is supported on hub axle 25 having a first frame mounting end 19a and a second frame mounting end 19b with a center axis extending there between, said axle adapted to receive a hub spacer 23 adjacent each sealed bearing 44 for positioning the hub assembly 10 between a first bicycle drop out 22a and second bicycle drop out 22b.

As is shown in FIGS. 5 & 8, hub assembly 10 includes a hub axle 25 that is hollow and includes a first frame mounting end 47a and a second frame mounting end 47b that are threaded internally to receive a pair of axle bolts 20 having a center axis extending there between such that said axle bolts in association with drop out guides 21a and 21b hold the sealed bearing assemblies 28, the hub shell 11, and the hub axle 25 together when the axle bolts 20 are assembled. In the preferred embodiment cog bolts 16 comprise torx (star) bolts.

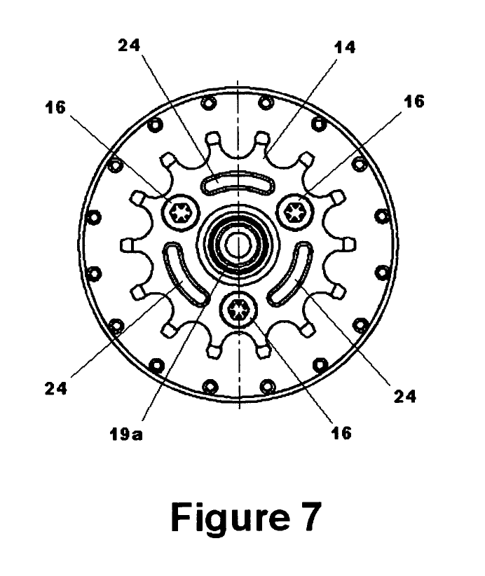

Referring to FIG. 7 the cog disc 14 shown mounted on hub face 13a of the molded unitary hub 11 having a cog ring 18 comprising integral keyways 17a & 17b and bolt holes 27 fastened to a selected hub shell face 13a by cog bolts 16 wherein the shear stress and torque loads are absorbed by the three arcuate keyways 17 or “Knuckle” and the three bolts 16 do nothing but hold the cog disc 14 flush to the hub face 13 a thereby enhancing ease of changing rear sprocket gears.

The present invention further includes a method for changing a cog disc 14 of a fixed gear bicycle employing a set of “Knuckles” 24 so that another cog disc with a different cog ring can be used comprising the steps of.

A) employing a 6 mm Allen (hex key wrench), loosen the two axle bolts 20 and remove the bicycle wheel from the bicycle dropouts 22 of the frame;

B) employing a T25 (torx wrench)(star wrench) completely remove the cog retaining bolts 16;

C) loft cog disc 14 off of the “Knuckles” 24;

D) place new cog disc 14 over the “Knuckles” 24 so that the cog bolt holes 27 line up; and

E) insert the torx (star) bolts and tighten the cog bolts 16a couple of turns at a time to insure the cog disc 14 go on evenly.

Preferably, the hub shell 11 is formed as a one-piece, unitary member. It will be apparent to those skilled in the art that the hub shell 11 can be constructed of any substantially rigid material, such as those materials, which are known in the art. For example, the hub body 11 can be constructed of any suitable metallic material, such as plated steel, stainless steel, aluminum, magnesium or titanium, as well as other nonmetallic materials, such as carbon fiber composite, ceramic or plastic.

Cog Mounting

In mounting the cog be sure that the faces are free of any dirt or debris as this will effect alignment of the chainline from the hub to the chainring. Place the cog over the Knuckles so that the bolt holes line up. Insert the torx head bolts which hold the cog to the Eye. Tighten the bolts (torx size wrench) a couple of turns at a time to insure the cog goes on evenly. The recommended torque spec is 50 in-lbs. This is to make sure the bolts do not vibrate loose. You might want to put some loctite on the threads as well. That's it. No special tools. No lockrings. And no sizes to match up.

Installing the INI Hub

Slide the hub into the frame dropouts. Be sure the drop out guides are seated fully and squarely on the drop out. Using a 6 mm Allen wrench, snug the drop out bolts up slightly to the drop outs. Check the chainline. If you need to adjust it, now is the time to do it. Just flip the cog over for the adjustment. Once the chainline is correct, tighten the drop out bolts.

Fog Cog Removal

Using a torx six 25 unscrew the bolts. All the way. Lift the cog off the Knuckles. If you need to you can carefully pry the cog up and off the Knuckles.

Disassembly of INI Hubs

The INI, so called, is comprised of four basic components; a hub shell 26, an axle 25, sealed bearings 28 and frame spacers 23. They all fit together with extremely tight tolerances, in the area of 0.002 of an inch, plus or minus. It is recommended that an operator should take the hub shell 26 to an experienced shop for any service contemplated.

### Alternate Embodiment

In an alternate embodiment, another form of drive train for a fixed- gear bicycle includes utilizing a sprockets that are mounted on the hub of the rear bicycle wheel. During pedaling, the bicycle chain engages this rear sprocket to rotate the rear wheel. If desired, when a bicycle rider stops pedaling, the rear wheel can be arranged to continue to rotate while the sprocket remains stationary. Accordingly, the rear hub is provided with a freewheel that has a one-way clutch. Freewheels are usually mounted on the rear hub of a bicycle for transmitting a driving force to the rear bicycle wheel in one rotation direction only. Freewheels are used so that the bicycle can advance freely without any rotation of the pedals. Freewheels include boss type freewheels which are mounted on the boss of the rear hub by being screwed onto the rear hub, and free hub type freewheels which are fastened to the rear hub as integral parts of the rear hub. Both types of freewheels are equipped with an outer tubular part, an inner tubular part which is installed radially inwardly of the outer tubular part so that the inner tubular part is free to rotate relative to the outer cylinder part, and a one-way clutch which is installed between the outer tubular part and inner tubular part for transmitting the driving force from the outer tubular part to the inner tubular part in one rotational direction only. The outer tubular part has a plurality of gears mounted thereon, while the inner tubular part is usually mounted on the rear hub of the bicycle.

In the alternate embodiment of the present invention includes employment of a freewheel assembly 29 being provided axially on one side of the hub assembly 10. The freewheel assembly 29 on a bicycle wheel having a hub axle 25 adapted to be mounted to a bicycle frame, a hub body 11 rotatably supported on the hub axle 25, an annular rim including a plurality of spokes holes extending outwardly from hub body and more specifically a conventional freewheel 29 being provided axially on one side of the hub body.

What is claimed is:

1. In a fixed gear bicycle having a frame and a chain drive sprocket, a hub assembly for use with conventional tools for changing a rear sprocket gear so that another gear can be employed comprising:
a hub axle having a center axis extending between a first frame mounting end and a second frame mounting end;
a chain extending between a front chain drive sprocket and a rear cog comprising a sprocket gear;
a hub unit having a hub shell of unitary molded construction having two hub faces comprising;
threaded bolt holes on both faces;
a plurality of molded arcuate locking keys protruding from each of the hub faces associated with locking keyways of a chain disc;
a rear cog comprising a single speed chain disc to be received by a selected hub face of the hub shell, comprising;
A plurality of integral arcuate locking keyways;
non-threaded bolt holes; and
having a peripheral cog ring for receiving the drive chain; and
a plurality of cog bolts in association with the non-threaded bolt holes; wherein said cog bolts can be employed for changing (removing and replacing) the rear sprocket gear with standard tools so that another gear can be used.

2. The hub assembly of claim 1 wherein the hub unit comprises a molded unitary hub shell that includes a hub axle that rotatable supports the hub and rear sprocket gear about a center axis of rotation by a pair of bearings mounted on bearing races at each end of the hub axle.

3. The hub assembly of claim 2 wherein the hub axle has a first frame mounting end and a second frame mounting end with a center axis extending there between adapted to receive a hub spacer for positioning the hub between a first and second bicycle drop out.

4. The hub assembly of claim 3 wherein the hub axle is hollow and includes a first frame mounting end and a second frame mounting end that are threaded internally to receive a pair of axle bolts and are threaded internally to receive an axle bolt and having a center axis extending there between such that said axle bolts in association with drop out guides hold the bearing assemblies the hub shell, the axle together when the axle bolts are assembled.

5. The hub assembly of claim 1 wherein the cog bolts comprise torx (star) bolts.

6. The hub assembly of claim 1 wherein the rear sprocket gear comprises a single speed chain disc received by the molded unitary hub having a cog ring comprising integral keyways and bolt holes fastened to the hub shell face by cog bolts wherein the shear stress and torque loads are absorbed by the three arcuate keyway or “Knuckle” and the three bolts do nothing but hold the cog flush to the hub face thereby enhancing ease of changing rear sprocket gears.

7. The hub assembly of claim 6 wherein the single speed chain disc can be substituted with a single speed chain disc having a different number of teeth while the bicycle is in use to accommodate a change in terrain having a different of angle of incline.

8. A method for changing a fixed bicycle gear employing a plurality of locking keys and arcuate keyways and fastening bolts for changing (removing and replacing) the hub (rear) gear on a fixed gear bicycle hub so that another gear can be used comprising the steps of
A) employing a 6 mm Allen (hex key wrench), loosen the two axle bolts and remove the bicycle wheel from the bicycle dropouts of the frame;
B) employing a T25 (torx wrench) (star wrench) completely remove the cog retaining bolts;
C) loft cog off of the “Knuckles”;
D) place new cog over the “Knuckles” so that the bolt holes line up; and
E) insert the torx (star) bolts and tighten the bolts a couple of turns at a time to insure the cogs go on evenly.

9. A bicycle hub assembly with freewheel comprising:
A) a hub axle having a center axis extending between a first frame mounting end and a second frame mounting end;
B) a hub unit having a hub body, a first spoke mounting portion located adjacent a first end of said hub body, a second spoke mounting portion located adjacent a second end of said hub body and an interior passageway extending through said hub body with said hub axle being rotatably supported therein;
C) a freewheel operatively coupled to said first end of said hub body, said freewheel including a driving member, a driven member and a unidirectional transmission mechanism, said driven member is non-rotatably coupled to said hub body, said unidirectional transmission mechanism being operatively coupled between said driving member and said driven member; and a sprocket assembly including a base portion with a unitary cog said base portion, said base portion being coupled to said driving member of said freewheel, said base portion of said sprocket assembly having an inner portion recessed within a recess of said first spoke mounting portion.
